(19) United States
(12) Patent Application Publication
(10) Pub. No.: US 2014/0249885 A1
(43) Pub. Date: Sep. 4, 2014

(54) SYSTEM AND METHOD FOR CUSTOMIZED SEARCH RESULTS BASED ON A SHOPPING HISTORY OF A USER, RETAILER IDENTIFICATIONS, AND ITEMS BEING PROMOTED BY RETAILERS

(71) Applicant: Catalina Marketing Corporation, St. Petersburg, FL (US)

(72) Inventors: Steven J. GREENFIELD, Palm Harbor, FL (US); Terrance Snyder, Tampa, FL (US); Don Irion, Fairfield, CT (US)

(73) Assignee: Catalina Marketing Corporation, St. Petersburg, FL (US)

(21) Appl. No.: 13/783,955

(22) Filed: Mar. 4, 2013

(51) Int. Cl. G06Q 30/06

(52) U.S. Cl. CPC G06Q 30/0625
USPC 705/7.29; 705/26.62; 705/14.53

(57) ABSTRACT

The disclosure relates to systems and methods for providing a custom search based on search input entered by a user, shopping history of the user, retailer identifications, and products to be promoted by the retailers. The system may leverage a combination of retailer and user information to customize search results for the user. The system facilitates a search platform where retailers may provide items being promoted such that promoted items may feature prominently in search results and/or be included in search results while non-promoted items may be featured less prominently n search results and/or be excluded from the search results. In this manner, the retailer may more successfully drive sales of promoted items. Users may benefit from use of the search platform by receiving relevant results that are customized for the user and include items that are being promoted so that the user is made aware of relevant promotions.

### FIELD OF THE INVENTION

The disclosure relates to systems and methods for providing custom search results based on search inputs entered by a user, shopping history, of the user, retailer identifications, and items being promoted by the retailers.

### BACKGROUND OF THE INVENTION

When searching online for one or more items, users typically enter search terms into their preferred search engines. Although these conventional search engines are adequate with respect to scouring and indexing the Internet for information, they typically do not have enough information on-hand about the user to be able to provide satisfactory custom search results for the user. As such, finding relevant items using conventional search engines can be difficult. Furthermore, using conventional search engines, it can be time consuming and difficult to search for relevant items that are on sale or otherwise being promoted by a retailer.

### SUMMARY OF THE INVENTION

The disclosure relates to systems and methods for providing custom search results based on search inputs entered by a user, shopping history of the user, retailer identifications, and items being promoted by the retailers. A system may include a search computer that leverages a combination of information known about different retailers, items offered by the different retailers, and a user requesting a search to customize search results for the user.

The system facilitates a search platform where retailers may provide items being promoted such that promoted items may feature prominently in search results and/or be included in search results while non-promoted items may be featured less prominently n search results and/or be excluded from the search results. In this manner, the retailer may drive sales of promoted items. Consumers may benefit from use of the search platform by receiving relevant results that are customized for the consumer and include items that are being promoted so that the consumer is made aware of relevant promotions.

The search input may include search terms, keywords, recipes, an identification of particular retailers, and/or other input used to find items such as products and/or services offered by various retailers. The search input may be entered by a user into a search interface exposed by the search computer to obtain search results.

In instances where the search input includes an identification of one or more retailers, the search computer may restrict search results to items offered by the identified retailers or may rank higher items offered by those identified retailers over items offered by other (non-identified) retailers. In instances where the search input does not include an identification of one or more retailers, the search computer may select particular retailers or use all retailers known by the system when identifying items to include in the search results.

In some embodiments, the search computer may use information known about the user making the search request to determine search results. For example, the search computer may obtain an identity of the user making the search request via a login process at a search interface exposed by the search computer or through various search agents operating at remote sites. The identity of the user may be used to obtain the user's shopping history, which may include items previously purchased by the user, items with which the user has interacted (e.g., by clicking an online ad related to the item, adding the item to an online shopping cart, making an inquiry about the item in a brick-and-mortar store, etc.), and/or items in which the user has otherwise shown an interest.

In some embodiments, the search computer may determine the shopping history based on transaction information received from different retailers such that the user's shopping history across multiple retailers, including across different chains or brands, may be obtained. For example, participating retailers may provide the system with transaction information that indicates prior purchases and/or other shopping behavior that is used to determine the user's shopping history.

In some embodiments, the shopping history may be used to develop a classification scheme related to the user. The classification scheme may be used to classify types of items for which the user likely is interested. For example, a classification may be generated for a user who shops (e.g., purchases or otherwise indicates an interest in) organic foods such that search results for particular items of food may include or rank higher organic food items and exclude or rank lower non-organic food items.

In some embodiments, the search computer may use information known about one or more retailers. For example, the search computer may obtain an identity of one or more retailers based on the search request, registration information from retailers registered with the system, and/or other information that can identify a retailer. Items offered by the retailer may be included in the search results based on the identity of the retailer. For example, items from a retailer that offers sporting goods may be included or ranked higher than items from a retailer that offers groceries in a search result set for a search input that searches for football.

In some embodiments, the search computer may receive from one or more retailers an indication of items that are being promoted using various types of promotions such as, for example, weekly sales, loyalty specials, store coupons, manufacturer coupons, and/or other types of promotions. The search computer may filter in or out items that are being promoted or rank higher such items in the search results than other (non-promoted) items.

In some embodiments, the search computer may receive inventory data that indicates a current stock of inventory for an item, a price for an item, and/or other information related to sales of the item. In some embodiments, the search computer may include at least some of the inventory data into the search results. For example, the search results may include a quantity of items in-stock for a particular retailer, a price of the item, and/or other inventory information. In some embodiments, the search computer may use the inventory data to include or rank higher items (e.g., items that are in stock) in the search results and exclude from or rank lower items in (e.g., items that are out of stock) the search results.

In some embodiments, the search computer may be configured to perform marketing analysis based on the search inputs and/or search results. For example, the search computer may determine items for which the user is searching and therefore determine that the user has an interest in those items. In some embodiments, future search results may be based on such interest. In some embodiments, the search computer may receive an indication that the user has selected or otherwise indicated an interest in a search result. In these embodiments, the search computer may determine that the user has an interest in information contained in the search result and may accordingly perform marketing functions and/or further enhance future search results.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system of providing custom search results based on search input entered by a user, shopping history of the user, retailer identifications, and items being promoted by the retailers, according to an embodiment of the invention.

FIG. 2 illustrates a flow diagram of a process for providing custom search results based on search input entered by a user, shopping history of the user, retailer identifications, and items being promoted by the retailers, an electronic offer management platform, according to an embodiment of the invention.

FIG. 3 illustrates a process for generating improved relevance of search results and marketing based on selection of one or more items of the improved search results, according to an embodiment of the invention.

FIG. 4 illustrates a search input interface 400 for entry of search inputs, according to an embodiment of the invention.

FIG. 5 illustrates a search results interface 500 for displaying ranked search results, according to an embodiment of the invention.

FIG. 6 illustrates a search results interface 500 for displaying filtered search results, according to an embodiment of the invention.

### DETAILED DESCRIPTION OF THE INVENTION

The disclosure relates to systems and methods for providing custom search results based on search input entered by a user, shopping history of the user, retailer identifications, and items being promoted by the retailers. As used herein, the terms “user” and “consumer” are used interchangeably throughout and the term “search results” may be used interchangeably with “search result set,” where a search result set includes one or more search result items.

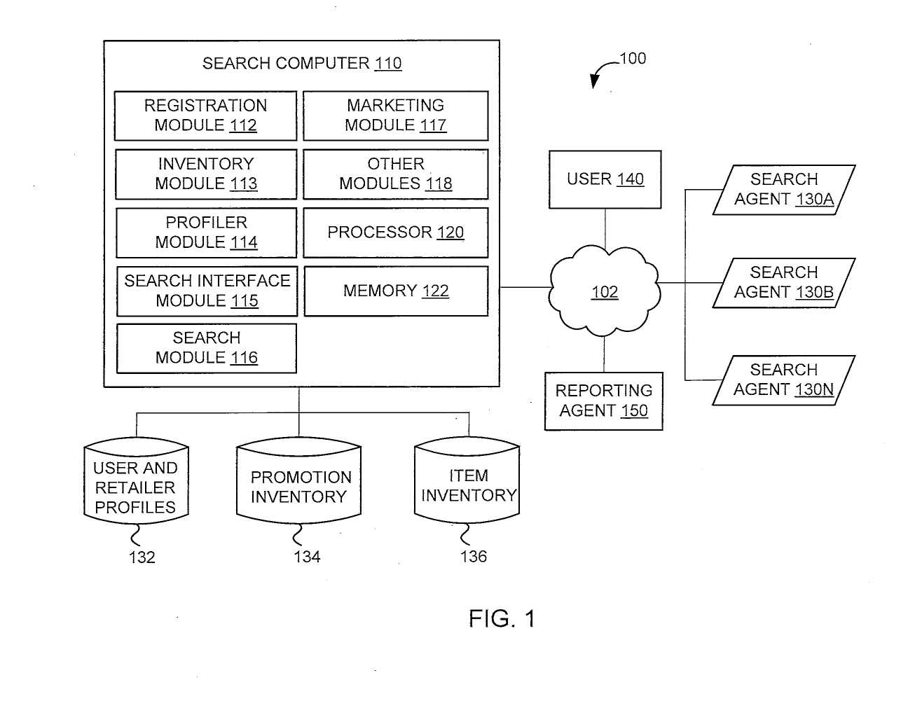

FIG. 1 illustrates a system 100 of providing custom search results based on search input entered by a user, shopping history of the user, retailer identifications, and items being promoted by the retailers, according to an embodiment of the invention. System 100 may include a search computer 110, one or more search agents 130 (illustrated in FIG. 1 as search agents 130A, 130B, . . . , 130N), a user and retailer profile database 132, a promotion inventory database 134, an item inventory database 136, a user 140, a reporting agent 150, and/or other components.

System 100 may obtain information related to retailers and users who request searches and leverage such information to customize search results for the user. A retailer may periodically provide system 100 with a list of items offered by the retailer, items being promoted, inventory information, sales transaction information, and/or other retailer information.

The transaction information may be associated with a particular user such that the user's shopping history may be generated based on the transaction information. The user's shopping history may be generated using other information as well, such as information indicating offline and/or online shopping behavior.

Search computer 110 may leverage information known about the different retailers, items offered by the different retailers, items promoted by the different retailers, and the user requesting a search to customize search results for the user. For example, the search computer may generate search results based on search inputs entered by a user, shopping history of the user, retailer identifications, items being promoted by the retailers, and/or other information.

Search computer 110 may include one or more processors 120 configured to execute one or more modules such as a registration module 112, an inventory module 113, a profiler module 114, a search interface module 115, a search module 116, a marketing module 117, and/or other modules 118. The various modules may be stored in a memory 122, which may comprise random access memory (RAM), read only memory (ROM), and/or other memory. The memory may store computer-executable instructions to be executed by the processor as well as data that may be manipulated by the processor. The storage media may comprise floppy disks, hard disks, optical disks, tapes, or other storage media for storing computer-executable instructions and/or data.

In some embodiments, registration module 112 may be configured to register various entities to use the platform. For example, registration module 112 may register a user 140, retailers, and/or other entities.

User 140 may register with the system via registration module 112. User 140 may include an individual, group of individuals (e.g., a household), and/or other entity that consumes and/or may search for items. User 140 may provide one or more identifiers such as a loyalty account identifier for which the consumer is enrolled, a payment card identifier (which may be appropriately de-identified or encrypted), and/or other identifier that may be used to identify the consumer. For example, when the system receives transaction information from retailers in association with a loyalty account identifier or a payment card identifier, the system may be able to determine that the transaction information is related to purchases made by the consumer at the retailer for purposes of determining whether offer requirements have been satisfied.

Registration module 112 may store an association between the consumer (e.g., a consumer identifier) and the loyalty program identifier in a memory, such as user and retailer profiles database 132. In this manner, the system may track transaction information and shopping history across different retailers and different chains of retailers in order to more fully customize search results for the user.

A retailer may register with the system via registration module 112. A retailer may include an entity that sells or otherwise offers items to consumers such as traditional brick-and-mortar stores, online electronic commerce sites, door-to-door sales providers, sales carts, and/or other retailers. Retailers may use a loyalty card that identifies a consumer. A loyalty card may be linked to a loyalty account and may include a loyalty identifier that identifies the account (and the consumer). The loyalty account may store transaction information such as items purchased. Consumers may be identified based on their use of the loyalty card and/or consumer identifier at checkout.

A retailer may agree during the registration process to provide transaction information for its consumers (e.g., its consumers who have registered with the platform). A retailer (e.g., a retailer identification) and an identification of its loyalty program (if any) may be stored in association with one another in a database such as user and retailer profiles database 132. In some embodiments, reporting agent 150 may operate on-site at a retailer's facility (whether online or brick-and-mortar) such that the reporting agent communicates transaction information to search computer 110. For example, reporting agent 150 may include hardware and/or software that communicates with or obtains transaction information from a point of sale terminal or other device used to checkout consumers.

In some embodiments, inventory module 113 may be configured to obtain and maintain an inventory of promotions. For example, via inventory module 113, retailers may provide the system with promotional information that indicates items being promoted, items that will be promoted, types of promotions, and/or other information related to promotions. A type of promotion may include a store coupon, a manufacturer coupon, a loyalty promotion, a sale, and/or other incentive that promotes an item.

Inventory module 113 may be configured to store the inventory of promotions in a memory such as promotion inventory database 134. In this manner, inventory module 113 facilitates use of available promotions in relation to searches and search results. For example, the inventory of promotions may be used to augment search results with an indication of available promotions, serve as a filter to filter in and/or out search result items, rank search result items, and/or otherwise be used in relation to search results. Search result items may include items that appear in the search results based on their relevance to the search input and search factors.

In some embodiments, inventory module 113 may be configured to obtain and maintain inventory information for items. The inventory information may include availability of items for individual retailers(e.g., whether in-stock, quantity in-stock, when inventory is expected to be in-stock, etc.), price (e.g., regular price, promotion price, unit price, etc.), planogram or location information for items in stores, retail locations at which an item is available, nutritional information, and/or other information related to an item.

Inventory module 113 may be configured to store the inventory of items in a memory such as item inventory database 136. In this manner, inventory module 113 may facilitate use of inventory information in relation to searches and search results. For example, the inventory information may be used to augment search results with an indication of availability of items, serve as a filter to filter in and/or out search result items, rank search result items, and/or otherwise be used in relation to search results.

In some embodiments, profiler module 114 may be configured to generate or otherwise obtain user profiles and/or retailer profiles. In some embodiments, user profiles may include a shopping history of the user, a demographic of the user, and/or other information that can be used to characterize the user. Profiler module 114 may be configured to receive transaction information and/or other shopping behavior from a retailer. For example, profiler module 114 may receive the transaction information from reporting agent 150. The transaction information may indicate items purchased by the user. The transaction information may be associated with a loyalty account identifier, thereby allowing the system to associate the transaction information with particular consumers.

In some embodiments, profiler module 114 may obtain a shopping history of the user and determine a user profile based on the shopping history. For example, profiler module 114 may determine a history of shopping organic food items. In this example, profiler module 114 may characterize the user (e.g., indicate in the user profile) that the user prefers organic items, which may drive future search results. Thus, when a user inputs a search for a recipe, organic recipe items may be included in the search results and may be ranked higher (e.g., placed in a manner within the search results that highlights higher ranked items) than non-organic items. In some embodiments, the shopping history may be obtained based on the transaction information and/or other shopping behavior received from the retailer.

The retailer profiles may characterize the retailer such as by indicating a type of retailer (e.g., grocer, sporting goods, online, brick-and-mortar, both online and brick-and-mortar, etc.), and/or other information. The profiler module may store the user and/or retailer profiles in a memory, such as user and retailer profiles database 132.

In some embodiments, search interface module 115 may be configured to communicate an interface that receives one or more search inputs and provides search results based on the search inputs. The interface may include a webpage of a search provider (e.g., the provider who operates search computer 110), a mobile application of the search provider, and/or other interface of the search provider that can convey search information.

In some embodiments, search interface module 115 may be configured to communicate with search agents 130 that operate remotely from search computer 110. For example, a search agent 130 may operate on one or more retailer's assets such as a website, a mobile application, and/or other asset of the retailer. This may give a branded appearance for the retailer while leveraging the searching capabilities of system 100. Search agents 130 may include various instructions such as Hypertext Markup Language (“HTML”), JavaScript, and/or other types of instructions that can receive search inputs and convey search results.

In some embodiments, search module 116 may be configured to generate search results based on search inputs (e.g., keyword entries, recipes, etc.), and a combination of search factors, which may include information known about the retailer and the user requesting the search. The search factors may include information from the retailer profile, the user profile, the promotion inventory database, item inventory database, and/or other information.

In some embodiments, search module 116 may be configured to use conventional information retrieval technology combined with a matrix-based preference scoring of the shopper's inputs using the search factors. In this manner, the search results may be relevant to the user and may leverage the information available to the system that has not previously been available to other search systems.

In some embodiments, one or more of the search factors may be weighted relative to other search factors to determine a relative importance of presenting search results. For example, certain information from a retailer profile may be deemed more important than information from a user profile when determining search results. The weights may account for such differences in importance.

In some embodiments, search module 116 may be configured to filter in or out search result items based on the search factors and the matrix-based preference scoring. For example, search module 116 may omit, from the search results, relevant items that are not being promoted by a retailer. In some embodiments, search module 116 may be configured to rank search result items within the search results. For example, search module 116 may be configured to include all relevant items in the search results but rank items that are being promoted higher than non-promoted items.

In some embodiments, marketing module 117 may be configured to determine, via search interface module 115 and/or search agents 130 which ones of the search result items the user selected (e.g., clicked) or otherwise has shown an interest. Marketing module 117 may generate promotions directed to the user based on the selected search result items. In some embodiments, search inputs entered by the user may be used to refine the user profile. For example, a user repeatedly searching for a particular item may have an interest in that item.

In some embodiments, the selected search result items may be used to further refine the user profile. For example, profiler module 114 may determine interests of the user based on selections of search results and include such interests in the user profile for that user. Likewise, profiler module 114 may determine interests of the user based on search inputs. In this manner, the system may generate marketing information and/or enhance future search results based on whether a user has selected or indicated an interest in a search result item.

The various components illustrated in FIG. 1 may be coupled to at least one other component via a network 102, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network.

In FIG. 1 and other drawing Figures, different numbers of entities than depicted may be used. For example, although only a single producer 104 is illustrated, more than one producer 104 may use the platform to propagate offers. Furthermore, according to various embodiments, the components described herein may be implemented in hardware and/or software that configure hardware.

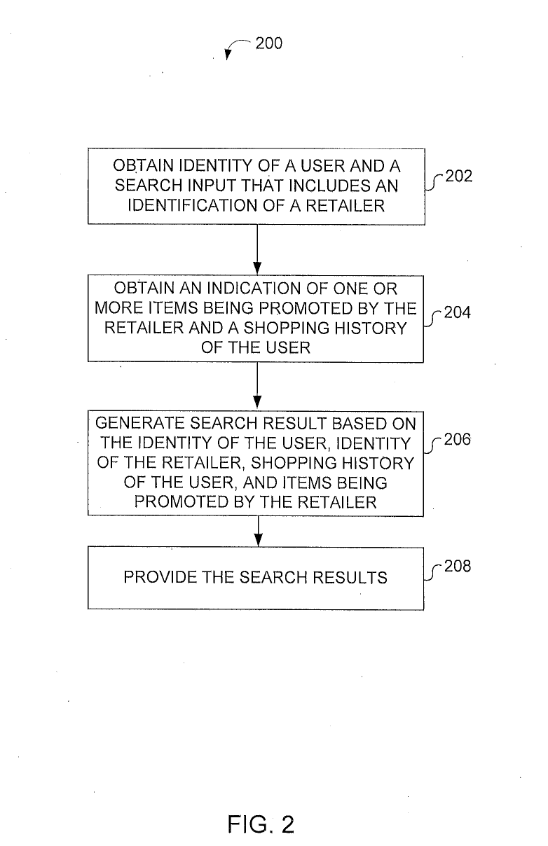

FIG. 2 illustrates a process 200 of providing custom search results based on search input entered by a user, shopping history of the user, retailer identifications, and items being promoted by the retailers, according to an embodiment of the invention. The various processing operations and/or data flows depicted in FIG. 2 (and in the other drawing figures) are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an operation 202, a search request comprising one or more search inputs and an identity of a user that originated the search request may be received. In some embodiments, the one or more search input may include an identification of one or more retailers.

In an operation 204, an indication of one or more items being promoted by the one or more retailers and a shopping history of the user that includes an indication of least one item shopped by the user may be obtained.

In an operation 206, a search result based on the identity of the user, the identity of the one or more retailers, the shopping, history of the user, the one or more search input, and the one or more items being promoted by the one or more retailers, wherein the search result comprises at least one item from among the one or more items being promoted by the one or more retailers. In an operation 208, the search results may be provided.

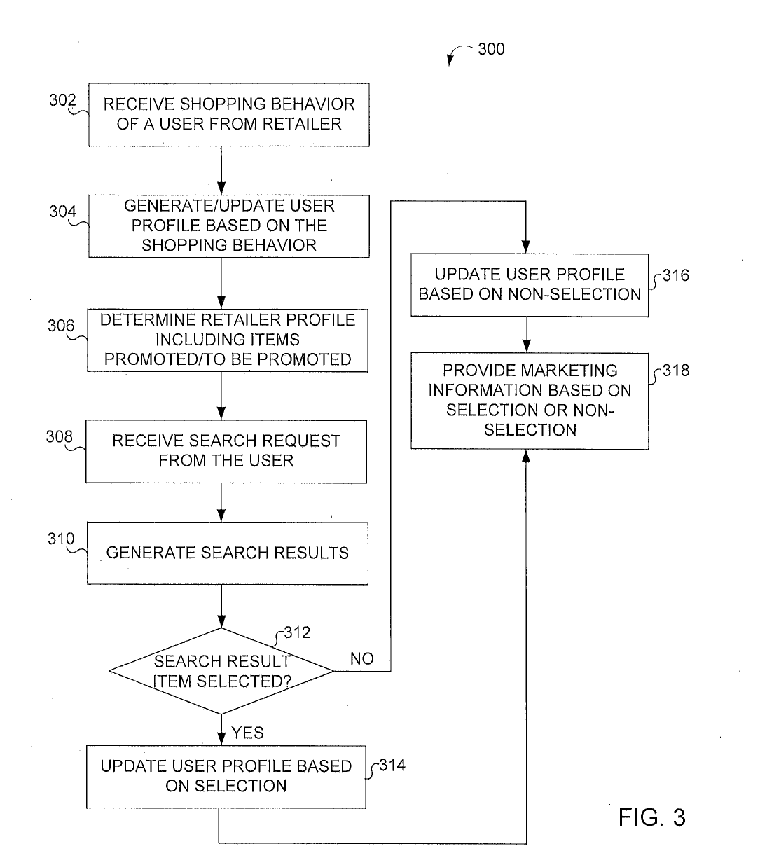

FIG. 3 illustrates a process 300 for generating improved relevance of search results and marketing based on selection of one or more items of the improved search results, according to an embodiment of the invention.

In an operation 302, a shopping behavior of a user may be received. For example, transaction information for a sales transaction associated with the user may be obtained from a retailer. The transaction information may indicate purchases of the user and may be associated with a user identification such as a loyalty account identifier, a financial account identifier (which may be encrypted), and/or other identifier that can identify the user in relation to the transaction. The shopping behavior may include information that is unrelated to purchases such as a showing of interest in an item.

In an operation 304, a user profile may be generated and/or updated based on the shopping behavior. For example, process 300 may be iterative in that the user profile may be updated periodically as new or additional information related to the user is received. In an operation 306, a retailer profile may be determined. The retailer profile may include items being promoted and/or to be promoted.

In an operation 308, a search request from a user may be received. The user may be identified in various ways to customize the search results for the user. In some embodiments, for example, a user may provide log on credentials onto a search website or search agent. In some embodiments, a cookie or other data file may be deposited onto a user device such that the identity of the user may be extracted from the cookie or other data file. In some embodiments, upon entering search inputs, the user may be prompted to provide a user identification known by the platform (such as a user identification that was provided during the registration process).

In an operation 310, search results may be generated based on search inputs from the search request, the user profile (such as the shopping history), the retailer profile (such as items being promoted), an identity of one or more retailers, and/or other information. The search results may include an identification of an item and/or promotions associated with the item.

In an operation 312, a determination of whether one or more items in the search results has been selected may be made. The one or more items may be selected when a user selects an actual item to obtain additional information, clips or otherwise requests an coupon (such as an electronic coupon), and/or otherwise indicates an interest in the one or more items. If in operation 312 a search result item has not been selected, the user profile may be updated based on the non-selection in an operation 316. Such non-selection may indicate that the user is not interested in any of the search results. Such non-interest may be used to refine the user profile. On the other hand, if in operation 312 a search result item has been selected, this may indicate user interest in the selected item and the user profile may be accordingly updated in an operation 314. Such interest may be used to validate that the user profile characterizes the user appropriately (at least with respect to the selected item).

In an operation 318, marketing information may be determined based on the selection or non-selection. For example, if a particular search result item was not selected, a promotion such as a coupon may be communicated to the user for the non-selected search result item in order to incentivize interest in the item.

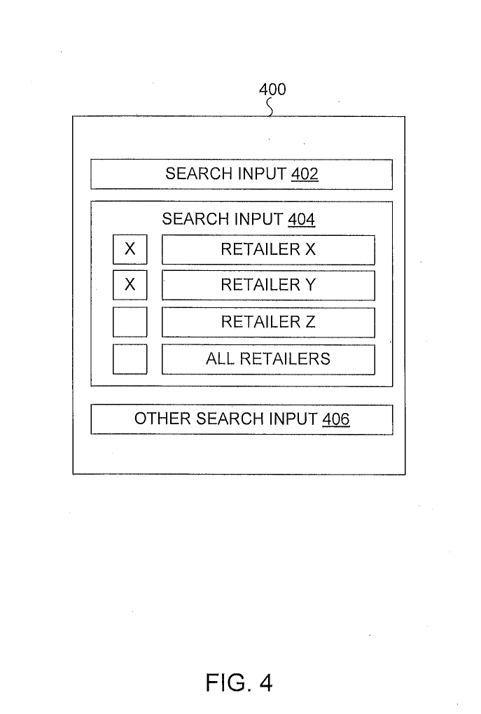

FIG. 4 illustrates a search input interface 400 for entry of search inputs, according to an embodiment of the invention. The interfaces illustrated in FIG. 4 and other drawing figures are for illustrative purposes only. Various interface components may be added, deleted, moved, or otherwise changed so that the configuration, appearance, and/or content of the screenshots may be different than as illustrated in the figures. Accordingly, the interface components as illustrated (and described in greater detail below) are exemplary by nature and, as such, should not be viewed as limiting.

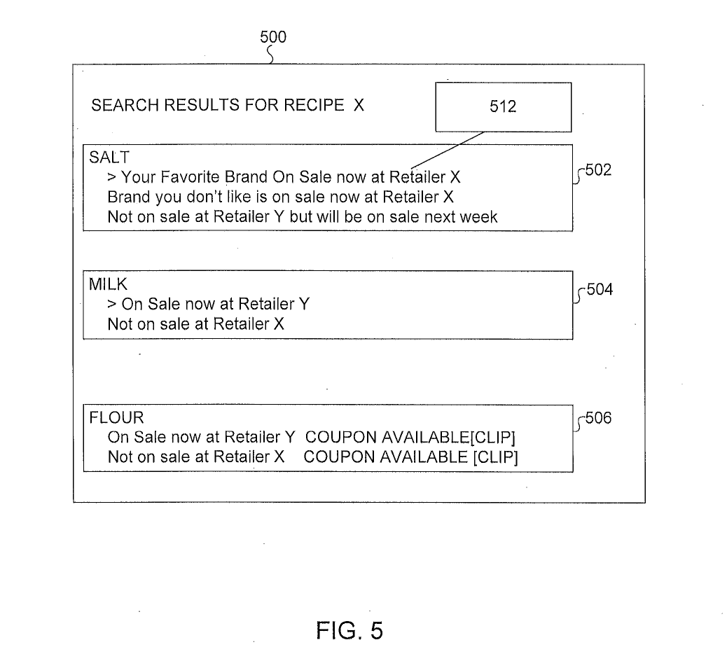

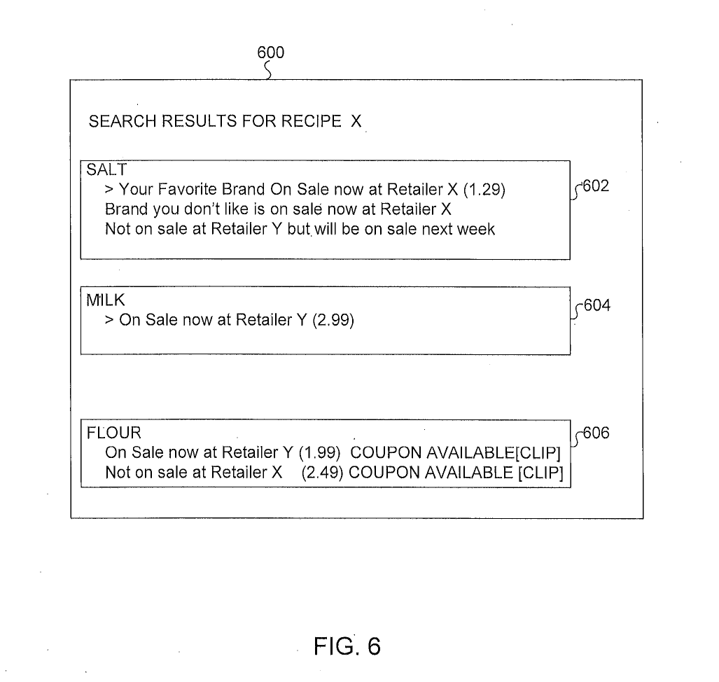

Search input interface 400 may include one or more search inputs 402, 404, 406. For example, search input 402 may include a text input such that keywords, phrases, characters, and/or other typed information may be input. Search input 404 may include a selectable list of retailers used to filter and/or rank the search results. Other search inputs 406 may include upload inputs and/or other conventional input components. In some embodiments, a search input may include a recipe input such that a user may search for particular recipes, and recipe list items may be returned, examples of which are illustrated in FIGS. 5 and 6.

FIG. 5 illustrates a search results interface 500 for displaying ranked search results, according to an embodiment of the invention. Search results interface 500 illustrates a listing of recipe items 502, 504, 506 (“SALT,” “MILK,” “FLOUR”) and respective search result items. Other search result items may be included and are not limited to recipe listings.

As illustrated, items being promoted (e.g., on sale) are ranked higher (e.g., placed closer to the top of the search results interface 500) than items not being promoted. In some embodiments, selection of each individual search result may cause a corresponding information component 512 to be displayed. Information component 512 may include additional details related to the selected item such as, for example, nutritional information, inventory (e.g, availability) information, planogram (in-store location) information, and/or other types of information related to the selected item. As would be appreciated, the information from information component 512 may be displayed alongside a search result item instead of or in addition to within the information component. In some embodiments, upon selection of an item, an interest in the selected item may be reported back to search computer 110 so that the user profile associated with the user making the selection may be updated and/or marketing information may be targeted to the user.

Although illustrated as being ranked based on whether items are on sale, other search factors may be combined with one another to rank the search result items. For example, referring to recipe item 502, three search result items related to “SALT” are displayed. The shopping history of the user may indicates a preference for a particular brand name (and/or classification of items such as organic, kosher, etc.) and a combination of the retailer, shopping history, search input for a particular recipe, and items being promoted may be used to generate a ranking of the three search result items of recipe item 502.

Referring to recipe item 506, in some embodiments, an availability of a coupon may be indicated in association with a search result item. In these embodiments, the user may electronically “clip” the coupon, which may be saved to a coupon account of the user or cause the coupon to be communicated to the user in paper and/or electronic form.

Although not illustrated, in some embodiments, search results interface 500 may include items from non-selected retailers ranked lower than items from selected retailers.

FIG. 6 illustrates a search results interface 600 for displaying filtered search results, according to an embodiment of the invention. Search results interface 600 is similar to search results interface 500 in that recipe items 602, 604, and 606 are displayed. However, instead of ranking based on whether an item is being promoted, search results interface 600 may omit altogether any items that are not being promoted. In some embodiments, search results interface 600 may display search result items that are not currently being promoted but will be promoted in the near future (e.g., within a predetermined and configurable time).

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A system configured to provide search results responsive to a search request from a user, the system comprising:
one or more processors configured to execute computer program modules, the computer program modules comprising:
a search module configured to:
receive a search request comprising one or more search inputs and an identity of a user that originated the search request, wherein the one or more search input comprises an identification of one or more retailers;
obtain an indication of one or more items being promoted by the one or more retailers and a shopping history of the user that includes an indication of least one item shopped by the user;
generate a search result set based on the identity of the user, the identity of the one or more retailers, the shopping history of the user, the one or more search input, and the one or more items being promoted by the one or more retailers, wherein the search result set comprises at least one item from among the one or more items being promoted by the one or more retailers; and
provide the search result set.

2. The system of claim 1, wherein the at least one item shopped comprises an item purchased by the user or an item for which the user has indicated an interest.

3. The system of claim 1, further comprising:
a profiler module configured to receive, from the one or more retailers, transaction information comprising one or more items purchased by the user; and
determine the shopping history based on the transaction information from the one or more retailers.

4. The system of claim 3, wherein the profiler module is further configured to:
determine a classification of products for which the user is interested based on the shopping history; and
determine search criteria used to generate search result set based on the classification of products.

5. The system of claim 4, wherein the search criteria comprises a type of item used to filter or rank the search result set.

6. The system of claim 3, wherein the transaction information is associated with a loyalty or discount program for which the user is enrolled with the one or more retailers.

7. The system of claim 1, further comprising:
a profiler module configured to receive, from the one or more retailers an indication of the one or more items being promoted by the one or more retailers.

8. The system of claim 1, wherein the search module is configured to exclude items not associated with a promotion.

9. The system of claim 1, further comprising:
an inventory module configured to determine whether products in the search result set are available at a retailer, wherein the search result set comprises an indication of the availability.

10. The system of claim 1, further comprising:
an inventory module configured to determine a price of items in the search result set, wherein the search result set comprises an indication of the price.

11. The system of claim 1, further comprising:
a marketing module configured to determine consumer preferences based on the search input.

12. The system of claim 1, further comprising:
a marketing module configured to determine consumer preferences based on interest in the one or more items of the search result set.

13. The system of claim 1, further comprising:
a marketing module configured to generate one or more promotions based on the determined consumer preferences.

14. A computer-implemented method of providing customized search results based on items being promoted by retailers, the method being implemented in a computer that includes one or more processors configured to execute computer program modules, the method comprising:
receiving, by the search module, a search request comprising one or more search inputs and an identity of a user that originated the search request, wherein the one or more search input comprises an identification of one or more retailers;
obtaining, by the search module, an indication of one or more items being promoted by the one or more retailers and a shopping history of the user that includes an indication of least one item shopped by the user;
generating, by the search module, a search result set based on the identity of the user, the identity of the one or more retailers, the shopping history of the user, the one or more search input, and the one or more items being promoted by the one or more retailers, wherein the search result set comprises at least one item from among the one or more items being promoted by the one or more retailers; and
providing, by the search module, the search result set.

15. The method of claim 14, wherein the at least one item shopped comprises an item purchased by the user or an item for which the user has indicated an interest.

16. The method of claim 14, further comprising:
receiving, by a profiler module, from the one or more retailers, transaction information comprising one or more items purchased by the user; and
determining, by the profiler module, the shopping history based on the transaction information from the one or more retailers.

17. The method of claim 16, the method further comprising:
determining, by the profiler module, a classification of products for which the user is interested based on the shopping history; and
determining, by the profiler module, search criteria used to generate search result set based on the classification of products.

18. The method of claim 17, wherein the search criteria comprises a type of item used to filter or rank the search result set.

19. The method of claim 16, wherein the transaction information is associated with a loyalty or discount program for which the user is enrolled with the one or more retailers.

20. The method of claim 14, the method further comprising:
receiving, by a profiler module, from the one or more retailers an indication of the one or more items being promoted by the one or more retailers.

21. The method of claim 14, the method further comprising:
excluding, by the search module, items not associated with a promotion.

22. The method of claim 14, the method further comprising:
determining, by an inventory module, whether products in the search result set are available at a retailer, wherein the search result set comprises an indication of the availability.

23. The method of claim 14, the method further comprising:
determining, by an inventory module, a price of items in the search result set, wherein the search result set comprises an indication of the price.

24. The method of claim 14, the method further comprising:
determining, by a marketing module, consumer preferences based on the search input.

25. The method of claim 14, the method further comprising:
determining, by a marketing module, consumer preferences based on interest in the one or more items of the search result set.

26. The method of claim 14, the method further comprising:
generating, by a marketing module, one or more promotions based on the determined consumer preferences.
